(19) United States
(12) Patent Application Publication
(10) Pub. No.: US 2022/0277084 A1
(43) Pub. Date: Sep. 1, 2022

(54) RISK ASSESSMENT OF ACCOUNT ACCESS

(71) Applicant: Hewlett-Packard Development Company, L.P., Spring, TX (US)

(72) Inventors: Joseph Yang, Cypress, CA (US); Roger S. Twede, Boise, ID (US); Deny Joao Correa Azzolin, Vancouver, WA (US)

(73) Assignee: Hewlett-Packard Development Company, L.P., Spring, TX (US)

(21) Appl. No.: 17/635,017

(22) PCT Filed: Oct. 4, 2019
(86) PCT No.: PCT/US2019/054787

§ 371 Date: Feb. 14, 2022

(51) Int. Cl. G06F 21/57; G06F 21/31

(52) U.S. Cl. CPC G06F 21/577; G06F 21/31

(57) ABSTRACT

To apply a security policy, described systems and methods receive an indication that a user account intends to interact with an image forming device. Based at least in part on attributes of the user account a risk level associated with enabling user account access to the image forming device is determined and a security policy to enable user account access is applied.

### BACKGROUND

Image forming apparatuses may provide capabilities for printing, scanning, copying, faxing or other functions. These functions may be activated locally or over a network by a user.

### BRIEF DESCRIPTION OF THE DRAWINGS

Examples will now be described, by way of non-limiting example, with reference to the accompanying drawings.

FIG. 1 illustrates a block diagram of an environment to provide secure access to an image forming device according to examples.

FIG. 2 illustrates an example user interface generated by a risk assessment system according to examples.

FIG. 3 illustrates an example user interface generated by a risk assessment system according to examples.

FIG. 4 illustrates an example user interface generated by a user device according to examples.

FIG. 5 illustrates a block diagram of a system to determine a security policy according to examples.

FIG. 6 is a flow diagram outlining an example method of security policy application according to examples.

### DETAILED DESCRIPTION

Image forming devices provide capabilities for printing, scanning, copying, faxing or other functions. These functions may be activated locally or over a network by a user. In addition, image forming devices can provide a user interface to enable users to interact with the image forming devices to select tasks to perform on those image forming devices.

Users may interact with image forming devices over a network from devices, such as personal computers, mobile devices, over network servers, or a combination of network connections. Network access to image forming devices may increase the potential for malicious access by unintended users of the image forming devices. However, applying a blanket security policy to restrict access to an image forming device may result in cumbersome access in situations where access presents minimal risk.

Disclosed herein are systems and methods to dynamically determine and apply a security policy to a user account based on a current risk level assessment of the account. For example, the risk level assessment may analyze attributes of a user account such as usage history, physical attributes of the user account or a user device, and behavioral attributes associated with the user account. A risk is determined for the user account and a security policy for the user can then be applied at an image forming device.

In some examples, systems may include mobile device components, image forming device components and security components. As the user's mobile device is in proximity to an image forming device, the user's mobile device detects a beacon including device identification information. A user may perform a gesture on the mobile device to confirm an intent to access an image forming device. For example, a user may perform a gesture such as shaking or turning the mobile device, entering a pattern on the mobile device, or performing an action for an image capture device. The mobile device can then transmit the user account information and image forming device identification to a security system to analyze the information and determine a risk level of the user's access. The security system then determines a security policy to apply to the user's access.

A security policy as described herein may prompt a user to provide a level of authentication based on a risk level assessment. For example, depending on a determined risk, an image forming device may request a username or password combination, 2-level authentication on a user device, badge access, gesture authentication, or other means of authentication.

In some examples, as a user device enters a proximity to image forming device, the user's mobile device containing an application detects a beacon from the image forming device, such as a Bluetooth beacon or other wireless signal. The beacon information including image forming device information user device information (for example, location), and user information (for example account information) is then transmitted to an security system that authenticates the user device and notifies the image forming device of the nearby user. The security system proceeds to identify the user of the mobile device and securely collects user-id, name, language, security policy, location or other information associated with the user, and shares that with the image forming device. As the user approaches the image forming device, a front panel may then display a user interface including an authentication request based on the determined security policy. The user may also perform a gesture to verify the intent to use the image forming device. This confirmation is shared with the security system and provided to the image forming device to provide access to the user.

Examples are further described herein with respect to the figures below. The figures represent examples and should not be considered limiting, but rather example implementations. In various examples, systems and methods may include fewer or additional components than have been shown in the figures. The systems and processes are generally described with respect to image forming devices, but may similarly apply to other apparatus to provide personalized user interfaces to users. For example, various apparatus may include printers, copiers, thermostats, refrigerators, multifunction devices, three dimensional printers, or other apparatus providing display screens or other user interfaces for personalized user interactions.

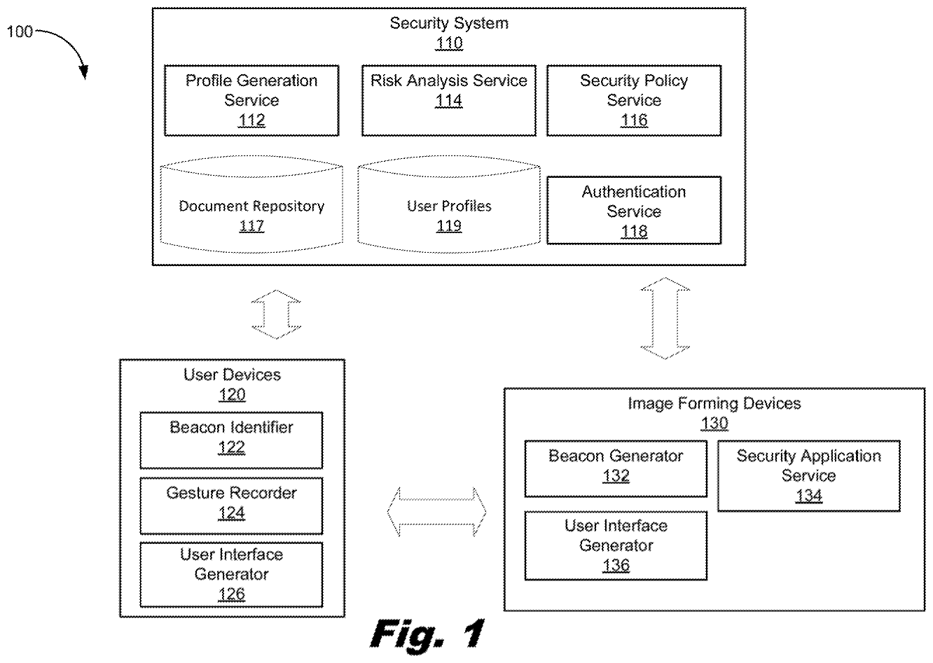

FIG. 1 is a block diagram showing an environment 100 that includes an security system 110, user devices 120, and image forming devices 130. The coordination of components in environment 100 enable a user of a user device 120 to approach an image forming device 130, such as a printer, and have the security system 110 analyze the user account to determine a security policy for the attempted access. In some examples, the security system determines the security policy in response to a user performing a gesture indicating an intent to interact with the image forming device 130. Following user authentication, security system 110 may enable access to the image forming device 130 for the user of user device 120. While the examples described with reference to FIG. 1 discuss processes and actions of components, in various implementations, these may be performed by other components. Furthermore, certain components may be further combined or separated from the examples illustrated in FIG. 1.

In some examples, user devices 120 may include portable devices such as a smartphone, tablet, or the like. The user devices 120 may include beacon identifier 122, gesture recorder 124, and user interface generator 126. As the user device 120 approaches an image forming devices 130, the user device may receive a signal identifying the image forming apparatus 130. The signal may include a beacon, such as a Bluetooth beacon, WiFi signal, or other wireless transmission. The beacon identifier 122 may include a token within the beacon that can be used to verify the image forming device 130. In some examples, tokens may be updated periodically and the user device 120 may receive additional beacon signals from an image forming device 130. The user devices 120 may also receive beacons from multiple image forming device 130 and identify tokens from each. In some examples, the received signal may include additional information such as the device type, device identification, device location, or other information analyzed by user devices 120.

The user device 120 may also include a gesture recorder 124 to record a gesture performed with respect to the user device 120. In some examples, the user device 120 may transmit an indication of the performed gesture to security system 110 indicating that the user of user device 120 intends to interact with image forming device 130. In some examples, the user device 120 provides a user interface requesting that the user perform a gesture in response to receiving a beacon from the image forming device 130. Acceptable gestures may include an input pattern on the user device 120, a motion of the user device (such as shaking or turning the user device 120), or a gesture captured by an image capture device of the user device. User interface generator 126 generates user interfaces for display on the user device 120. For example, user interfaces may be used to verify user intent to interact with an image forming device 130, prompt a user to provide additional authentication for security purposes, enable the user to instruct an image forming device 130 to perform one or more functions, or otherwise enable user interaction with an image forming device 130.

The user device 120 may transmit the beacon, device identification, and details of the user account and user device to security system 110 for analysis. For example, the user device 120 may transmit to the security system a user identification associated with the user, a location of the user device 120, additional data about the user device 120 or information received from image forming device 130. The security system 110 can then determine a risk assessment for the user account to determine a security policy to apply. The user device 120 may include additional details of user device 120, such as a user identification associated with the user, a location of the user device 120, or additional data about the user device 120 or information received from image forming device 130.

Based on the information of the user account and data received about a current access attempt at an image forming device 130, a risk analysis service 114 may determine a security policy to apply to the attempted access. For example, the risk analysis service 114 may access a user profile from a set of user profiles 119 associated with a user account. The profile may include information about usage history associated with the user that may indicate potential risk of the user account. For example, the usage attributes may include typical frequency of use, last use, types of actions, or other data describing a typical use scenario for a user account. The profile may also include behavioral attributes for the user account. For example, behavioral attributes may include changes to the user's account, security settings, gestures performed by the user device, or other indications of changes to behavior that may indicate a change in risk level for the user account. Physical attributes can include physical characteristics of the attempted access to the image forming device. For example, the physical attributes can include an access location, access time, device configuration, or the like. In the case that there is an unexpected change to some attributes, the security system 110 may evaluate the account access as having a higher risk assessment and applying a higher security policy to access the image forming devices 130.

User profiles 119 stored by the security system 110 may be generated by the profile generation service 112. The service may record user device characteristics, user account information, or other information about user accounts and image forming device 130 access attempts. In some examples, the user profiles 119 are updated with changes to user accounts, user devices 120, and continued access attempts by user accounts.

Security policy service 116 applies security policy based on an output of the risk analysis service 114. For example, the security policy service 116 may determine to escalate an applied security policy in response to a high-risk assessment. For example, depending on a determined risk, an image forming device may request a username or password combination, 2-level authentication on a user device, badge access, gesture authentication, or other means of authentication. The policy can be provided to the image forming devices 130 to request authentication from user devices 120. In response to the authentication information being entered into a user device 120 or image forming devices 130, the authentication service 118 can verify the user account and send an indication to the image forming devices 130 to enable access for the user. The security system 110 may also provide access to a document repository 117 having jobs for completion by the image forming device 130 or additional user information that can be used by image forming devices 130 to provide personalized information to a user.

The image forming devices 130 may include a beacon generator 132, a security application service 134, a user interface generator 136, and settings and preferences 138. The image forming devices 130 are described generally herein as multi-function printers but may include any appliance that provides secure connections to user devices 120. The image forming devices 130 may communicate with image delivery system 110 to receive data associated with users of user devices 120 as well as to authenticate user devices 120. The image forming devices 130 may also communicate with user devices 120 to verify the user.

The beacon generator 132 may generate and broadcast a beacon to be received by user devices 120 that enter into the vicinity of the image forming devices 130. For example, the beacon generator 132 may generate a beacon that includes a token identifying the image forming devices 130. In some examples, the beacon generator 132 may receive beacons the security system 110 and the image forming devices 130 may receive and transmit a beacon without generating beacons themselves. In some examples, the beacon can also include a unique identification of the image forming devices 130. The image forming device 130 may also provide the beacon to security system 110 to compare to beacon's provided by user devices 120. The beacon may be ephemeral and updated periodically, for example, every 30 seconds, 1 minute, or other amount of time that enables comparison of a beacon provided by the user device 120 and generated by image forming device 130. In some examples, the security system 110 may store a log of a past several beacons broadcast by image forming devices 130 to provide verification in the case of a delays in transmission between components. For example, the image delivery system 110 may request a password, fingerprint, or other verification from user device 120 to indicate that the user is currently using an application related to image forming devices 130. Furthermore, the user verification service 116 may confirm that the location reported by a user device 120 is in the same area as that of image forming device 130 or perform other security analysis to authenticate the user device 120 for using the image forming device 130.

The image forming devices 130 may also have a security application service 134 to apply a security policy determined by the security system 110. For example, the image forming device 130 and user device 120 may start a session after the beacon is identified and processed by the user device 120. The image forming devices 130 can then receive information from the user device 120 or the security system 110 that identifies a user that is using the user device 120. In some examples, a user interface generator 136 may provide an interface for a user to interact with to apply the security policy. For example, a user device may send a recorded gesture to the security system 110 that then determines a security policy and directs the image forming device 130 to apply a policy for authenticating the user before enabling access to the image forming device 130.

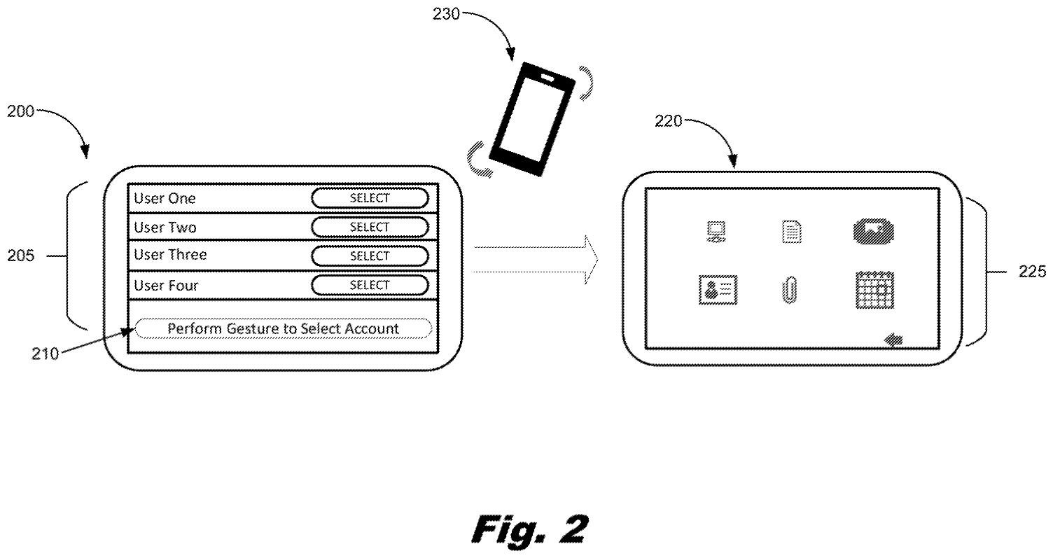

After authenticating a user for access to the image forming device 130, the user interface generator 136 generates a user interface to display on a display screen of the image forming device 130. For example, user interface generator 136 can also provide a user interface enabling tasks to be performed on the image forming devices 130. Examples of user interfaces that may be generated by user interface generator 136 are described further with references to FIGS. 2-4 below.

In some examples, security system 110 can generate personalize interface information to provide for use by user interface generator 136 of the image forming devices 130. For example, the personalization service 118 can retrieve information shared by the user device 120, such as collecting user-id, name, language, security policy, location information or the like. The image delivery system 110 may also include a document repository 117 or additional user profile information 119 to enable personalized user interfaces. For example, the document repository 117 may include remotely stored documents associated with an account of the user of user device 120. A user of the image forming devices 130 can then operate a user interface to access and print or otherwise use such remotely stored documents at image forming device 130.

Table 1 below illustrates example scenarios that may be analyzed to determine a risk level associated with an attempt to access an image forming device 130 by a user account. The scenarios described show usage attributes, behavioral attributes, and physical attributes that affect the potential risk for user access to an image forming device 130. As shown, in the first two scenarios, the security policy is not changed. Accordingly, a security system 110 may provide a security policy based on a standard authentication of the user account. In the third scenario, the geolocation is unrecognized for the user account and this is the first user of a particular image forming device by the user or user account. Accordingly, the security system 100 may determine to increase the security policy applied by the image forming device 130. For example, the security policy may be increase to requesting 2 step authentication of a username and password combination rather than enabling access based on a gesture received from a user device 120.

TABLE 1

| | Usage | Behavioral | Physical | Security |
|---|---|---|---|---|
| Scenario | Attributes | Attributes | Attributes | Change |
| Scenario | Last used: | Security | Device Present: yes | None |
| 1 | yesterday | Level: Stable | Geolocation: | |
| | | Gesture: | Recognized | |
| | | Recognized | Access Time: 3pm | |
| | | | Configuration: | |
| | | | Recognized | |
| Scenario | Last used: | Security | Device Present: yes | None |
| 2 | 10 Days | Level: Stable | Geolocation: | |
| | | Gesture: | Recognized | |
| | | Recognized | Access Time: 5pm | |
| | | | Configuration: | |
| | | | Recognized | |
| Scenario | Last used: | Security | Device Present: yes | Escalate |
| 3 | yesterday | Level: Stable | Geolocation: | |
| | | Gesture: | Unrecognized | |
| | | Recognized | Access Time: 1pm | |
| | | | Configuration: | |
| | | | Recognized | |
| | | | First Device use | |

FIG. 2-4 illustrate example user interfaces that may be presented on a display of an image forming device or a user device. For example, the image forming device, may be one as described with reference to FIG. 1 above. For example, the user interface may be generated by a user interface generator 136 or user interface generator 126 based on information received from security system 110 as further described herein.

FIG. 2 illustrates an example user interface 200 that shows a set of users 205 that have been selected for display by the image forming device. For example, the set of users 205 may be selected based on proximity to the image forming device, based on most recent to authenticate a beacon associated with the image forming device, or based on other criteria. The user interface 200 also includes an option 210 directing users to perform a gesture to indicate their intent to interact with the image forming device. The gesture may be recorded by an application executing on a user device and transmitted to a security system to verify the user's intent. The gesture may be analyzed by the security system to determine whether the user intends to interact with the image forming device as well as analyzing usage attributes, behavioral attributes, physical attributes, or other data regarding the user account and attempted access. The security system may then provide the image forming device with a security policy or user interface to enforce and display to enable access to the image forming device. As shown in updated user interface 220, in response to receiving a gesture from the user device 230 the security system has determined that an enhanced security policy is not warranted based on risk assessment for the attempted access. Accordingly, the user interface 220 includes a personalized interface 225 that provides access to the image forming device as well as actions to perform at the image forming device. In some examples, additional authentication may be performed at the user device 230 to enable access to the image forming device.

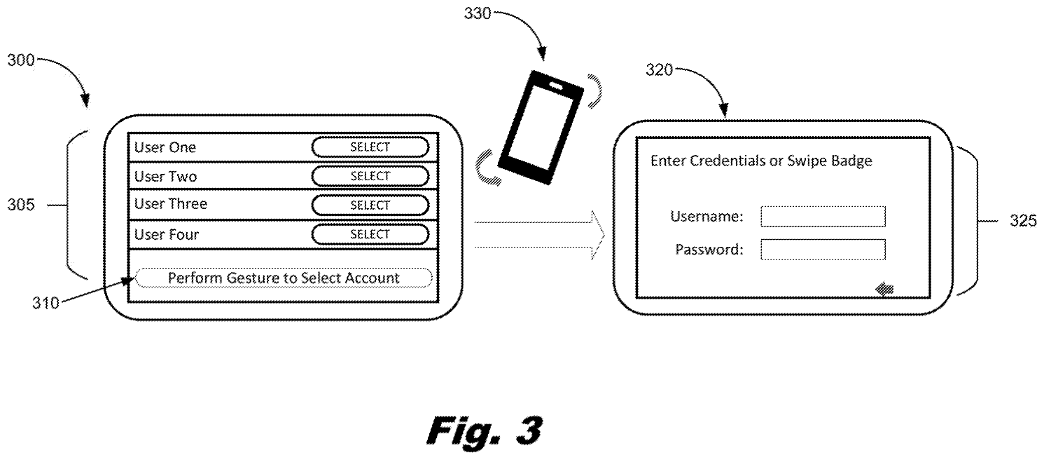

FIG. 3 illustrates an example user interface 300 that shows a set of users 305 that have been selected for display by the image forming device. For example, the set of users 305 may be selected based on proximity to the image forming device, based on most recent to authenticate a beacon associated with the image forming device, or based on other criteria. The user interface 300 also includes an option 310 directing users to perform a gesture to indicate their intent to interact with the image forming device. The gesture may be recorded by an application executing on a user device and transmitted to a security system to verify the user's intent. The gesture may be analyzed by the security system to determine whether the user intends to interact with the image forming device as well as analyzing usage attributes, behavioral attributes, physical attributes, or other data regarding the user account and attempted access. The security system may then provide the image forming device with a security policy or user interface to enforce and display to enable access to the image forming device. As shown in updated user interface 320, in response to receiving a gesture from the user device 330 the security system has determined that an enhanced security policy is warranted based on risk assessment for the attempted access. For example, the risk assessment may be for a first access to a new image forming device, from a new location, from a user account that recently changed certain settings, or outside of a normal access time for the user account. Accordingly, the user interface 320 includes an interface 325 that applies an enhanced security policy to seek additional security authentication in response to the risk assessment. Based on additional user input, the image forming device may enable access to the image forming device and present the user with additional selections to operate the image forming device. provides access to the image forming device as well as actions to perform at the image forming device. In some examples, additional authentication may be performed at the user device 330 to enable access to the image forming device.

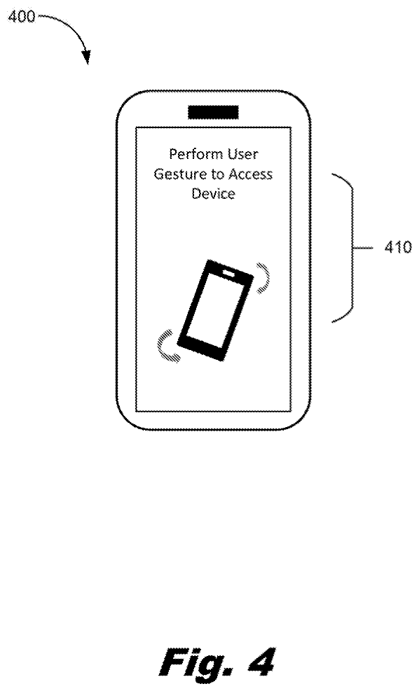

FIG. 4 is an example user device 400 displaying an example user interface 410. The user interface provides instructions to a user to perform a gesture indicating an intent to interact with an image forming device. In some examples, the user interface 410 may be generated in response to a user device receiving a beacon from the image forming device. The gesture may be recorded by the user device 400 and transmitted to a security system to verify the user's intent and enable analysis of the risk assessment of the attempted access. In some examples, a user may perform a gesture such as shaking or turning the mobile device, entering a pattern on the mobile device, or performing an action for an image capture device. The gesture may be recorded by accelerometers, image capture devices, touchscreen signals, or other input devices of the user device 400. The transmittal to the security system may include a signal representative of the recorded gesture and may be compared to a selected gesture associated with a user account. In some examples, the user device or an image forming device may provide a particular gesture for the user to perform that may change based on image forming device, timing, or other characteristics to further verify the user's intent.

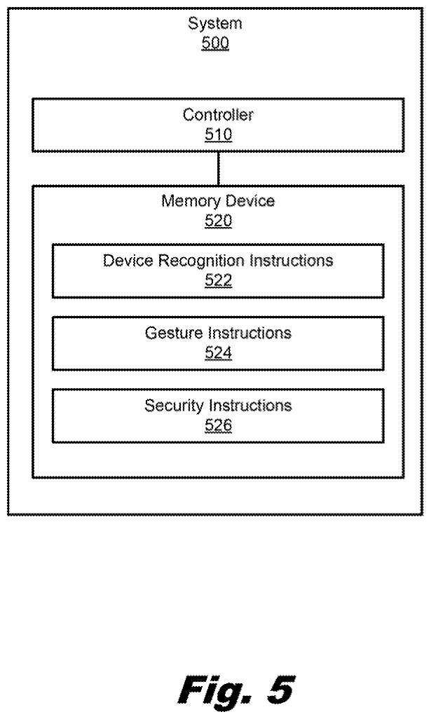

FIG. 5 is a block diagram of an example system 500 to assess risk levels associated with user access to image forming devices. The system may be part of a remote system, such as a security system 110 as described with reference to FIG. 1, that coordinates authentication for user accounts accessing the system or an image forming device. In some examples, one or more components of system 500 may be part of the image forming apparatus. System 500 may include at least one computing device that is capable of communicating with at least one remote system. In the example of FIG. 5, system 500 includes a controller 510 couple to a memory device 520. Although the following descriptions refer to a single processor and a single computer-readable medium, the descriptions may also apply to a system with multiple processors and computer-readable mediums. In such examples, the instructions may be distributed (e.g., stored) across multiple computer-readable mediums and the instructions may be distributed (e.g., executed by) across multiple processors.

Processor 510 may be a central processing unit (CPUs), a microprocessor, and/or other hardware devices suitable for retrieval and execution of instructions stored in memory device 520. In the example system 500, controller 510 may receive and execute device recognition instructions 522, gesture instruction 524, and security instructions 526. As an alternative or in addition to retrieving and executing instructions, controller 510 may include an electronic circuit comprising a number of electronic components for performing the functionality of an instruction in memory device 520. With respect to the executable instruction representations (e.g., boxes) described and shown herein, it should be understood that part or all of the executable instructions and/or electronic circuits included within a particular box and/or may be included in a different box shown in the figures or in a different box not shown.

Memory 520 may be any electronic, magnetic, optical, or other physical storage device that stores executable instructions. Thus, memory device 520 may be, for example, Random Access Memory (RAM), an Electrically-Erasable Programmable Read-Only Memory (EEPROM), a storage drive, an optical disc, and the like.

Device recognition instructions 522 stored on memory device 520 may, when executed by the controller 510, cause the controller 510 to determine that a user device is in proximity of an image forming device based on a token received from the user device and a device identification of the image forming device. For example, the user device may provide an account identification associated with a user, profile information of the user, a device identification of the user device, or other information about the user.

Gesture instructions 524 stored on memory device 520 may, when executed by the controller 510, cause the controller 510 to receive a recorded gesture from the user device indicating that a user account associated with the user device intends to access the image forming device. For example, signals representing the gesture may be transmit to the system 500 from a user device and be verified by the system 500.

Security instructions 526 stored on memory device 520 may, when executed by the controller 510, cause the controller 510 to provide a security policy to the image forming device to enforce upon an access request for the user account. For example, the security policy may be determined based on a risk assessment from a number of attributes associated with the user account, user device, image forming device, usage history, or the like. The security policy may be changed to reflect a risk of the user and request higher authentication if there is potential higher risk for an attempted access to the image forming device.

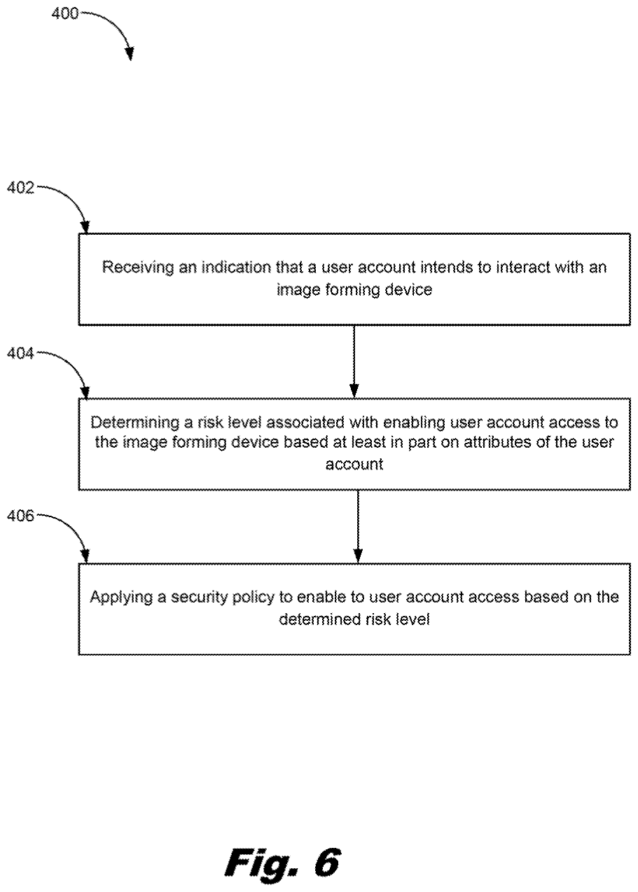

FIG. 6 illustrates an example flow diagram 600 that may be performed by a security system to provide risk assessment for access to image forming devices. For example, the flow diagram may be performed by systems as described with reference to FIG. 1. In various examples, the processes described in reference to flow diagram 600 may be performed in a different order or the flow diagram may include fewer or additional blocks than are shown in FIG. 6.

Beginning in block 602, a security system receives an indication that a user account intends to interact with an image forming device. For example, receiving the indication that the user account intends to interact with the image forming device may include receiving a recorded gesture performed by or with a user device associated with the user account. The user may perform the gesture in response to a user interface of the user device or of an image forming device.

In block 604, the security system determines a risk level associated with enabling user account access to the image forming device based at least in part on attributes of the user account. In some examples, determining the risk level is based on usage attributes, physical attributes, and behavioral attributes. For example, the security system may monitor user interactions with a plurality of image forming devices and generate usage attributes for the user account based on the monitored user interactions. The usage attributes then contribute to the risk level assessment. Physical attributes may be determined based on physical attributes of the user account based on characteristics of a user device associated with the user account

In block 606, the security system applies a security policy to enable user account access based on the determined risk level. For example, applying the security policy may include increasing a level of authentication in response to determining that the risk level is over a threshold. The threshold may be set differently depending on the user account or an associated entity of the user account. In some examples, the threshold is set by an amount of risk change since a previous access to an image forming device.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. In various examples other non-transitory computer-readable storage medium may be used to store instructions for implementation by processors as described herein. Accordingly, some examples provide a program comprising code for implementing a system or method as claimed in any preceding claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features.

1. A method comprising:
receiving an indication that a user account intends to interact with an image forming device;
determining a risk level associated with enabling user account access to the image forming device based at least in part on attributes of the user account; and
applying a security policy to enable user account access based on the determined risk level.

2. The method of claim 1, wherein applying the security policy comprises increasing a level of authentication in response to determining that the risk level is over a threshold.

3. The method of claim 1, further comprising:
monitoring user interactions with a plurality of image forming devices; and
generating usage attributes for the user account based on the monitored user interactions, wherein the usage attributes contribute to the risk level assessment.

4. The method of claim 1, further comprising:
determining a plurality of physical attributes of the user account based on characteristics of a user device associated with the user account, wherein the physical attributes contribute to the risk level assessment.

5. The method of claim 1, wherein receiving the indication that the user account intends to interact with the image forming device comprises receiving a recorded gesture performed by a user device associated with the user account.

6. The method of claim 5, further comprising comparing the recorded gesture with a stored gesture of the user account, wherein the gesture comprises one or more of an input pattern on the user device, a motion of the user device, or a gesture captured by an image capture device of the user device.

7. The method of claim 1, further comprising providing a communication to the image forming device to enable access to the user account.

8. A system comprising:
a memory device to store instructions; and
a controller coupled to the memory device to execute instructions stored thereon, the controller to:
determine that a user device is in proximity of an image forming device based on a token received from the user device and a device identification of the image forming device;
receive a recorded gesture from the user device indicating that a user account associated with the user device intends to access the image forming device; and
provide a security policy to the image forming device to enforce upon an access request for the user account.

9. The system of claim 8, wherein the controller is further to authenticate the user account in response to receiving authentication attempt details from the image forming device.

10. The system of claim 8, wherein the controller is further to determine a risk level associated with enabling user account access to the image forming device based at least in part on attributes of the user account.

11. The system of claim 10, wherein the controller is further to increase a level of the security policy in response to determine that a risk level for the user account has increased.

12. The system of claim 10, wherein the controller is further to compare the recorded gesture with a stored gesture of the user account, wherein the gesture comprises one or more of an input pattern on the user device, a motion of the user device, or a gesture captured by an image capture device of the user device.

13. The system of claim 10, wherein the controller is further to:
monitor user interactions with a plurality of image forming devices; and
generate usage attributes for the user account based on the monitored user interactions, wherein the usage attributes contribute to the risk level assessment

14. A non-transitory computer-readable storage medium comprising a set of instructions executable by a processor to:
periodically generate beacon information including a token and device identification of an image forming apparatus;
receive a recorded gesture indicating that a user account associated with a user device intends to access the image forming apparatus;
determine a risk level associated with enabling user account access to the image forming device based at least in part on attributes of the user account; and
apply a security policy to enable to user account access based on the determined risk level.

15. The non-transitory computer-readable storage medium of claim 14, wherein the instructions further cause the processor to increase a level of the security policy in response to determine that a risk level for the user account has increased.
